(19) United States
(12) Patent Application Publication
(10) Pub. No.: US 2003/0214890 A1
(43) Pub. Date: Nov. 20, 2003

(54) Optical disc and method for recording data on the same

(75) Inventors: Kyung-Geun Lee, Gyeonggi-do (KR); In-Sik Park, Gyeonggi-do (KR); Du-Seop Yoon, Gyeonggi-do (KR); Jae-Seong Shim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/438,925

(22) Filed: May 16, 2003

(30) Foreign Application Priority Data
May 20, 2002 (KR) 2002-27951
Oct. 26, 2002 (KR) 2002-65673

(51) Int. Cl. G11B 7/00

(52) U.S. Cl. 369/53.17; 369/59.25

(57) ABSTRACT

An optical disc and a method for recording data on the optical disc. The method for recording data on the optical disc capable of recording/reproducing includes the step of performing linking before a physical cluster in which recording starts to be continuously done. The recording method proposes a standard for handling continuous recording, overwriting and a defective region, thereby ensuring compatibility of a disc recording/reproducing apparatus while improving reliability of recording/reproducing of an optical disc.

### CROSS-REFERENCE TO RELATED APPLICATIONS

This application claims the priority of Korean Patent Application No. 2002-27951 filed on May 20, 2002 and 2002-65673 filed on Oct. 26, 2002, in the Korean Intellectual Property Office, the disclosure of which is incorporated herein in its entirety by reference.

### BACKGROUND OF THE INVENTION

1. Field of the Invention

The present invention relates to an optical disc and a method of recording data on the same, and more particularly, to an optical disc in which linking at a portion in which recording starts is defined and a method of recording data on the optical disc.

2. Description of the Related Art

In general, optical discs are widely adopted as data recording media used in optical pickup systems for non-contact type recording/reproducing. They are classified into compact discs (CDs) and digital versatile discs (DVDs) depending on data recording capacity. Examples of optical discs capable of reading, recording, or erasing include 650 MB CD-Recordable (CD-R), CD-Rewritable (CD-RW), and 4.7 GB DVD+RW. In addition, a High Definition-DVD (HD-DVD) disc with recording capacity of 23 GB is currently being developed.

In a CD-RW that can be rewritten, a packet is the basic recording unit, the structure of which is shown in FIG. 1. The packet contains a plurality of run-in blocks 103 and run-out blocks 110 preceding and following a user data block 105 in which the user data is recorded. A link block 100 is located at the beginning of the basic recording unit enabling continuous recording. If the user data block 105 contains a defective region in which recording cannot be performed, recording has to be completed before the defective region. However, no definitions or standards are available for a method of recording/reproducing over an optical disc having a defective region or the structure of the disc using the same. Thus, it is likely that a method of handling defective regions varies by each manufacturer of optical disc recorders/reproducers. This raises concerns over compatibility between disc drives, which may commonly occur in CD, DVD, and HD-DVD families. Thus, a need exists for standardization of optical discs.

The applicant of this patent application has disclosed under Korean Patent Laid Open No. 2000-75374 a method of handling a defective region on a DVD-RW disc in which a predetermined linking scheme is applied immediately after the defective region and a recording medium using the same method.

However, in the case of optical discs (HD-DVDs) with recording capacity of 20 GB or more, there are no definitions for a method of recording capable of effectively dealing with continuous recording or overwriting or occurrence of defective regions and the structure of a disc using the same. Thus, this may cause compatibility problems in disc drives as described above, which may lead to unstable recording/reproducing operation. Thus, it is highly desirable to have a new definition or standard for a method of recording a disc and a disc structure using the same capable of effectively dealing with continuous recording or overwriting in the presence of defective regions.

### SUMMARY OF THE INVENTION

The present invention provides an optical disc in which linking is performed in a portion where recording begins upon continuous recording or overwriting of data on the disc and recording is terminated in the last run-out block of an area to be recorded, and a method of recording data on the optical disc, thus ensuring the compatibility of disc recording/reproducing apparatuses and improving disc recording/reproducing performance.

The present invention also provides an optical disc in which recording termination data indicative of the termination of recording is written before a defective region and linking is performed after the defective region during continuous recording or overwriting of data thus enabling seamless recording/reproducing, and a method of recording data on the optical disc with the defective region.

In accordance with an aspect of the present invention, there is provided a method of recording data on an optical disc capable of recording/reproducing, which includes continuously performing linking before a physical cluster in which recording starts.

A run-in and a run-out may be provided before and after the physical cluster, respectively, for accurately recording data, and linking may occur between the run-in and the run-out preceding the run-in and the physical cluster in which recording starts.

The method may include a run-in and a run-out before and after the physical cluster, respectively, and recording data indicative of the end of recording in the last run-out of an area on which recording is to be performed.

The run-in and the run-out may contain guard1 and guard2 protecting user data, respectively, and the guard2 of the last run-out may be recorded to have a pattern different from a neighboring guard2.

The recording may be continuously done on a blank area on which no previous data has been recorded, next to a pre-recorded area or performed by overwriting data on a portion of an area on which previous data has been recorded.

An aspect of the present invention also provides a method of recording data on an optical disc capable of recording/reproducing. The method includes: performing linking before a physical cluster on which data recording starts during continuous data recording on the physical cluster, wherein a run-in and a run-out are located before and after the physical cluster, respectively; and performing linking between a run-in and a run-out following a defective region when a recording area contains the defective region on which recording cannot be done.

Furthermore, in order to achieve the above and/or other aspects, the present invention provides an optical disc capable of recording/reproducing data. The optical disc includes: a plurality of physical clusters, each having data recorded thereon; and a run-in and a run-out provided before and after each physical cluster, respectively, to accurately record data. One feature of this optical disc is that linking during continuous recording occurs between the run-in and the run-out immediately preceding the run-in and the physical cluster on which continuous recording starts.

One embodiment of the present invention also provides an optical disc capable of recording/reproducing data. The optical disc includes: a plurality of physical clusters, each having data recorded thereon; a run-in and a run-out provided before and after each physical cluster, respectively, for accurately recording data; and a defective region which may occur prior to recording data or during recording. In the optical disc, when continuous recording is done on an area on the optical disc containing the defective region and the physical cluster, linking occurs between the run-in and the run-out of the previous physical cluster preceding the area on which recording starts.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail embodiments thereof with reference to the attached drawings in which:

FIG. 1 shows the structure of a basic recording unit applied to a conventional CD-RW;

FIG. 2A shows a structure in which data is recorded in a single physical cluster;

FIG. 2B shows a recording structure in which data is sequentially recorded in a plurality of physical clusters;

FIG. 3A shows a portion of an optical disc on which data is to be sequentially recorded according to an embodiment of the present invention;

FIG. 3B shows an optical disc and a method of recording data on the optical disc according to the optical disc of FIG. 3A;

FIG. 4A shows a portion of an optical disc in which data is to be continuously recorded according to another embodiment of the present invention;

FIG. 4B shows an optical disc and a method for recording data on the optical disc according to another embodiment of the present invention;

FIG. 5A shows a data structure where defects are generated due to an address or ID error; and

FIG. 5B is a diagram illustrating a linking implementation method where defects are generated due to an address or ID error.

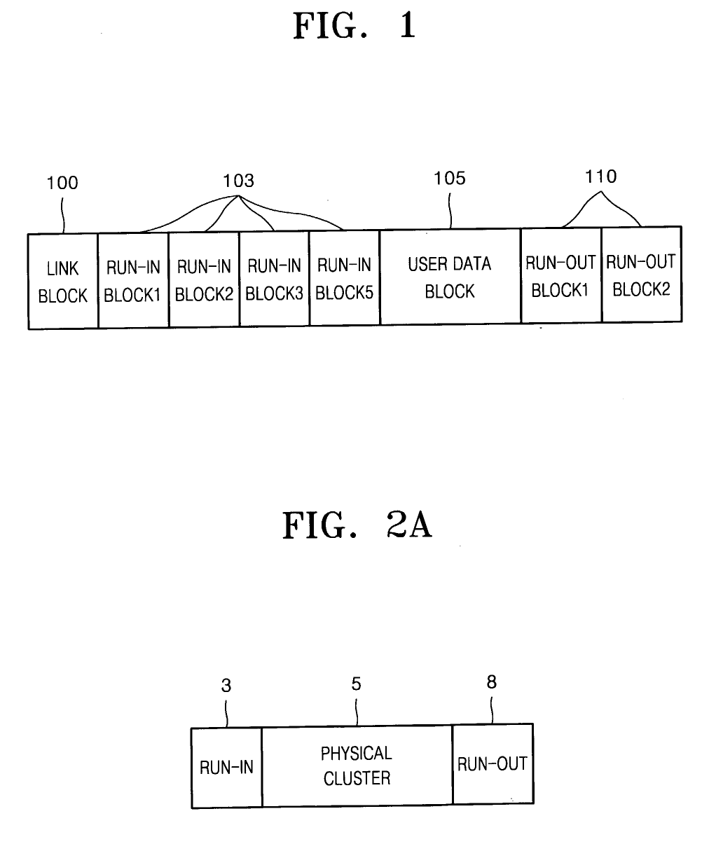

### DETAILED DESCRIPTION OF THE PREFERRED EMBODIMENTS

Embodiments of the present invention are described in more detail below and are illustrated in the attached drawings. Reference numerals are used to identify elements of the embodiments, with like reference numerals corresponding to like elements.

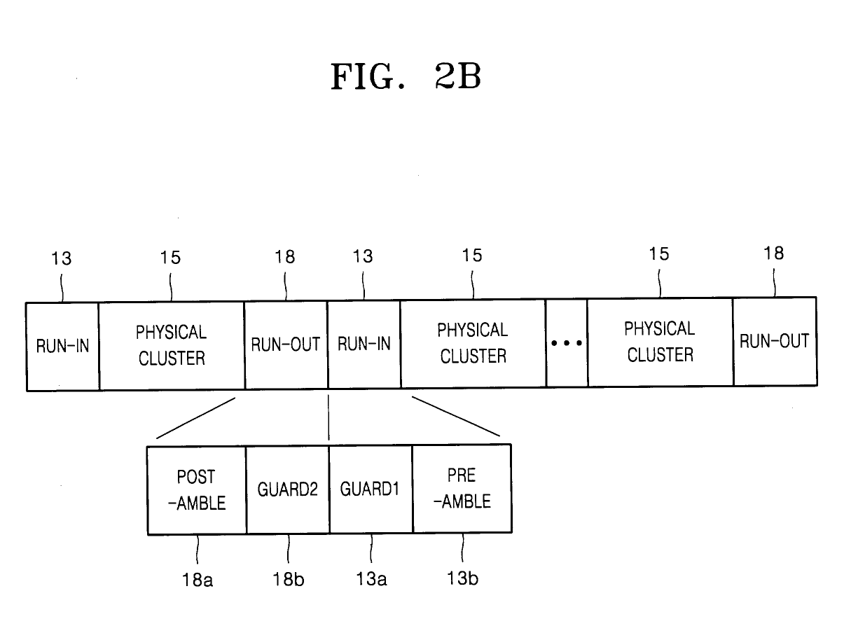

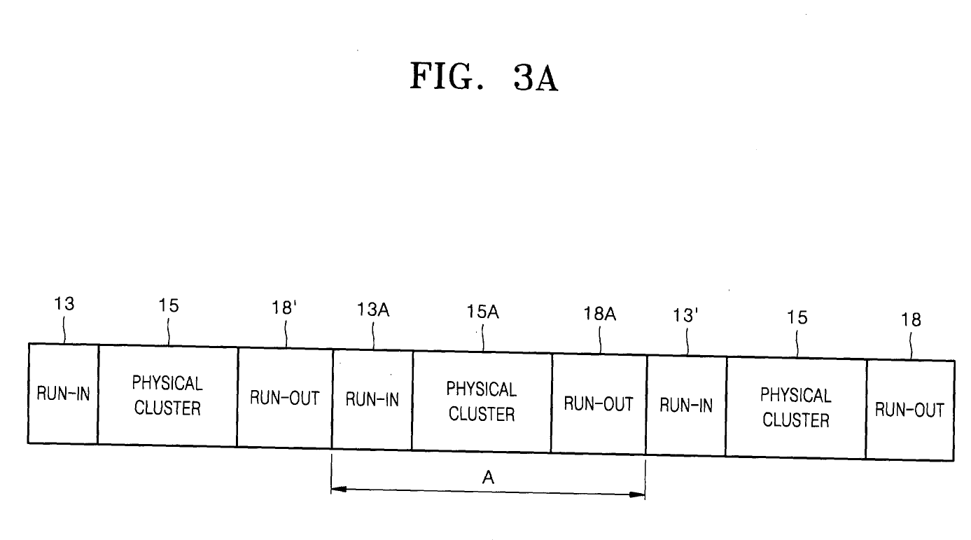

FIG. 2A shows a structure in which data is recorded in a single physical cluster 5 of an optical disc capable of recording and/or reproducing data. FIG. 2B shows a structure in which data is continuously recorded in a plurality of physical clusters 15. The physical clusters 5 and 15 contain data frames with a capacity of 2 KB each, a synch frame indicating a synch, data controlling DC offset, and an error correction code (ECC) correcting errors. Here, the ECC may have a capacity of 64 KB.

Run-ins 13 and run-outs 18 are defined before and after the physical clusters 15, respectively. The run-ins 13 and the run-outs 18 allow data to be recorded precisely on the physical clusters 15 during recording/reproducing of data. That is, if data that is intended to be written to a data frame in a physical cluster 15 deviates from the precise location of the data frame and is written to the run-ins 13 or the run-outs 18 within a predetermined allowable range when data recording starts, this helps to correct location errors thus enabling data to be recorded seamlessly.

The run-in 13 may contain a guard1 13a having a predetermined pattern to overcome overwriting due to inaccuracy or changes in a recording start point and a pre-amble 13b to perform signal processing such as locking or synchronizing. The run-out 18 may include a post-amble 18a for signal processing and a guard2 18b solving overwriting due to variations in the recording start point. Eventually, the guard1 13a and the guard 18b serve as a buffer protecting user data. Data recording ends in the last run-out 18 of a recording area.

Although a physical cluster 15 has been described as the smallest recording unit on which user data is recorded, examples of smallest recording units may include a sector, an ECC block, and a frame.

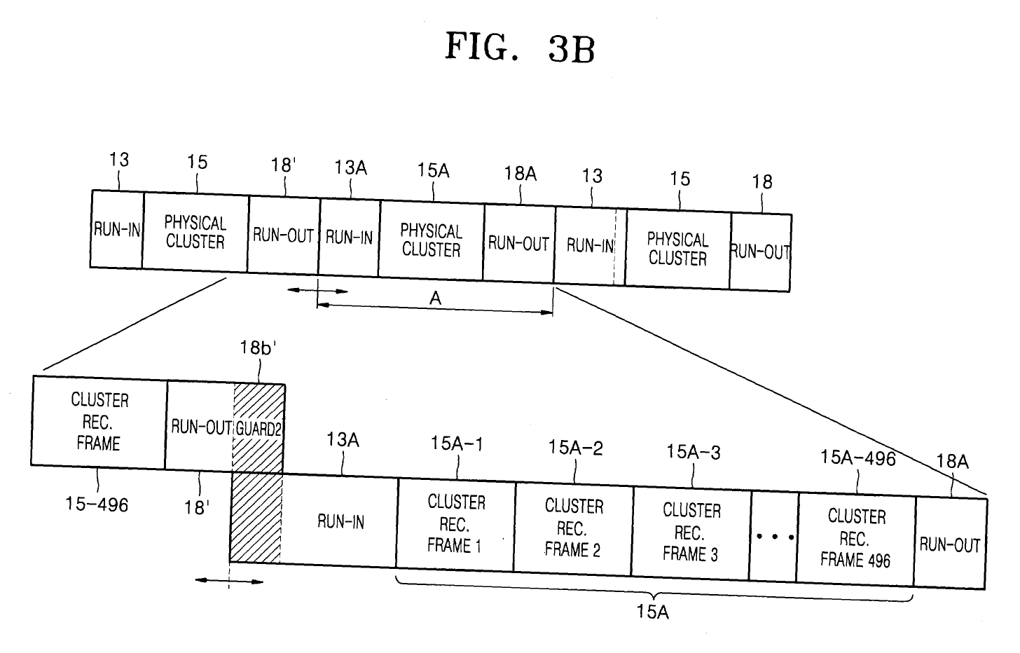

FIG. 3A shows an example in which data is recorded on an area denoted by A following the plurality of physical clusters 15 on which data has been recorded. Here, the area A may be a blank area on which no data is recorded or an area in which data has been recorded. In the latter case, data is recorded over the existing data.

As described above, each physical cluster 15 is preceded and followed by the run-in 13 and the run-out 18, respectively. A run-in, a physical cluster, and a run-out in the area denoted by A are represented by 13A, 15A, and 18A, respectively. According to a method of recording data on an optical disc according to an embodiment of this invention, as shown in FIG. 3B, linking occurs between the run-in 13A at the beginning of the area A on which recording is to be performed and a run-out 18′ preceding the run-in 13A.

Linking enables data to be recorded seamlessly if a drive cannot find a location to be recorded when data starts to be recorded on an area of the disc so data is recorded on a portion of the run-out 18′ or a portion of the neighboring run-in 13A. In this case, linking occurs in such a way that an error is corrected by recording data on the relevant area of the run-out 18′ or run-in 13A. That is, linking is performed by correcting an error if data is not recorded at an accurate recording start point upon continuous recording. Occurrence of linking is indicated by an arrow between the run-out 18′ and the run-in 13A.

For example, a guard2 18b′ in the run-out 18′ may have a length of 300 channel bits or more and may include a pattern containing at least 3T and 5T. Here, 3T or 5T denotes the length of a mark recorded on the disc.

As described above, linking performed between the run-out 18′ preceding the area A on which data is to be recorded and the run-in 13A enables continuous recording or overwriting. After linking has been performed, recording starts on the physical cluster 15A following the run-in 13A. The end of recording is represented by recording data having a pattern different from that of a neighboring guard2, in a guard2 in the last run-out 18A of an area to be recorded.

Here, the physical cluster 15A may include 496 recording frames 15A-1, 15A-2 . . . 15A-496 following the run-in 13A. A 496-th recording frame 15-496 of the physical cluster 15 is followed by the run-out 18A.

Although recording has been done in the single physical cluster 15A according to the above embodiment of this invention, the same applies also to sequential recording on a plurality of physical clusters. That is, when continuous recording or overwriting is done on a plurality of physical clusters, linking is performed between a run-in at the beginning of an area on which recording starts and a run-out. This recording method may apply to both of the cases in which recording is done continuously on a blank area next to the pre-recorded area, on which no previous recorded data is available, and in which overwriting is done on a portion of an area on which previous data has been recorded.

A feature of an optical disc recorded according to the embodiment described above is that linking occurs between the run-out 18′ preceding the area A to be recorded and the run-in 13A. Another feature is that the end of recording is indicated by recording so that the guard2 of the last run-out 18A on the recording area A may have a pattern different from that of a neighboring guard2.

An optical disc and a method of recording data on the optical disc according to another embodiment of the present invention will now be described.

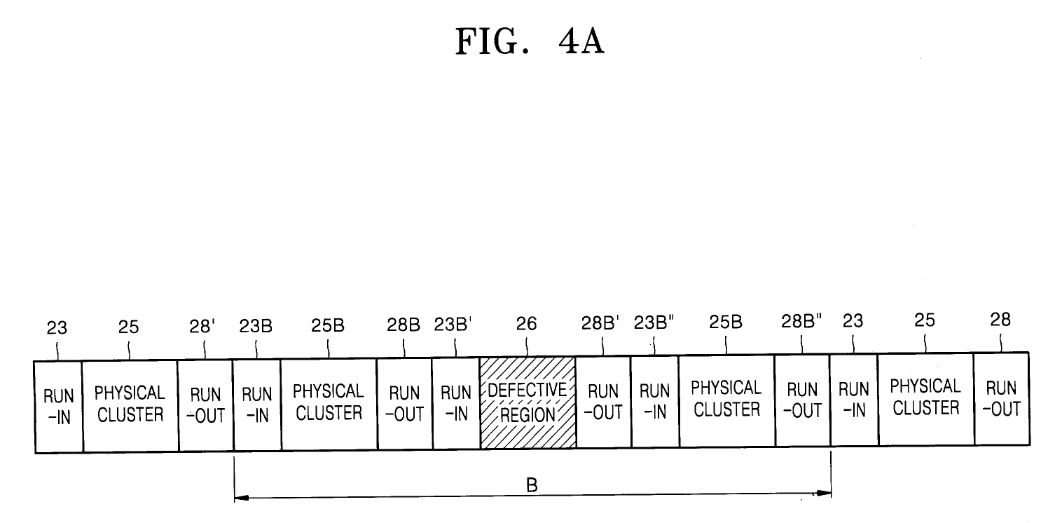

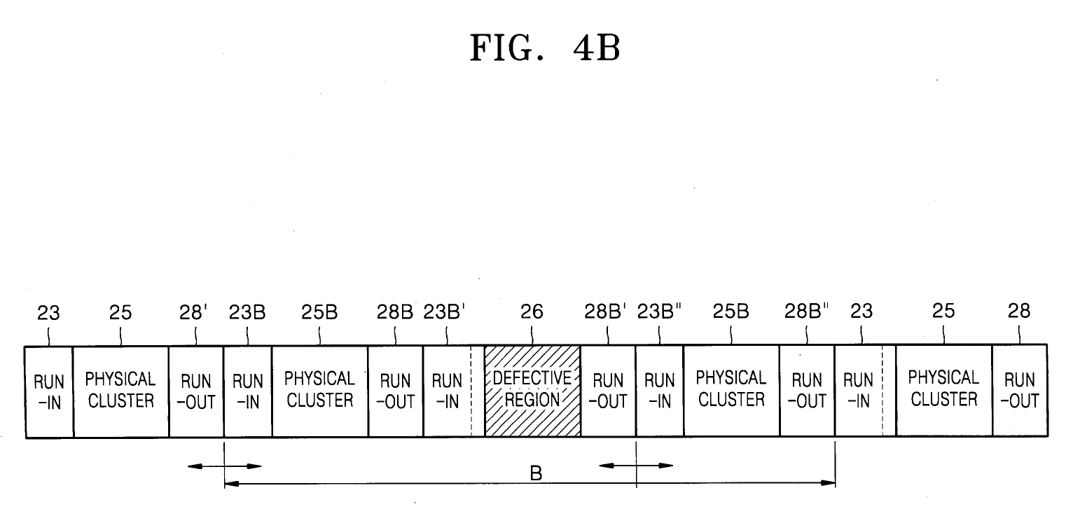

FIG. 4A shows an optical disc capable of recording/reproducing containing a defective region 26 on which data recording/reproducing cannot be done when data is recorded/reproduced in a plurality of physical clusters 25 on the disc. In this case, an address of the defective region 26 is stored in a defect list region. The defective region 26 includes one discovered upon verifying the disc as well as one upon recording/reproducing data. A run-in 23 and a run-out 28 are specified before and after the physical cluster 25, respectively to enable accurate data recording. The run-in 23 may contain a guard1 of a predetermined pattern to overcome overwriting due to inaccuracy or changes in a data recording start point and a preamble for signal processing such as locking or synchronizing. The run-out 28 may include a post-amble for signal processing and a guard2 of a predetermined pattern eliminating overwriting due to variations in the recording start point.

The optical disc recording method described above is applied when recording is performed on the optical disc containing the defective region 26 as described above. In FIG. 4A, an area to be recorded is denoted by B. A run-in, a physical cluster, and a run-out of the recording area B are denoted by the respective reference numerals to which the character B is appended. Here, recording refers to continuous recording on a blank area next to the prerecorded area, on which no previous recorded data is available, and overwriting done on an area on which previous data has been recorded.

First, as shown in FIG. 4B, linking occurs between a run-out 28′ preceding the recording area B and a run-in 23B so that recording can start. This linking is performed before a physical cluster 25B so that a location error within a predetermined allowable range is corrected if the disc fails to find an accurate recording start point when the recording starts. Occurrence of linking is indicated by an arrow shown in FIG. 4B. Since the same method as described with reference to FIG. 3B applies to this linking, a detailed description thereof will be omitted.

Next, since recording cannot be done on the defective region 26, recording end data indicative of the end of recording is written to the run-out 28B preceding the defective region 26. The recording end data can be written to the guard2 so that it has a pattern different from that of a neighboring guard2.

Subsequently, when recording resumes after the defective region 26, linking occurs between a run-out 28B′ and a run-in 23B″ following the defective region 26. The linking is performed in the same manner as described above. In FIG. 4B, occurrence of linking is indicated by an arrow between the run-out 28B′ and the run-in 23B″. Furthermore, recording end data can be written by recording a guard2 of the last run-out 28B″ on the recording area B to have a pattern different from that of a neighboring guard2.

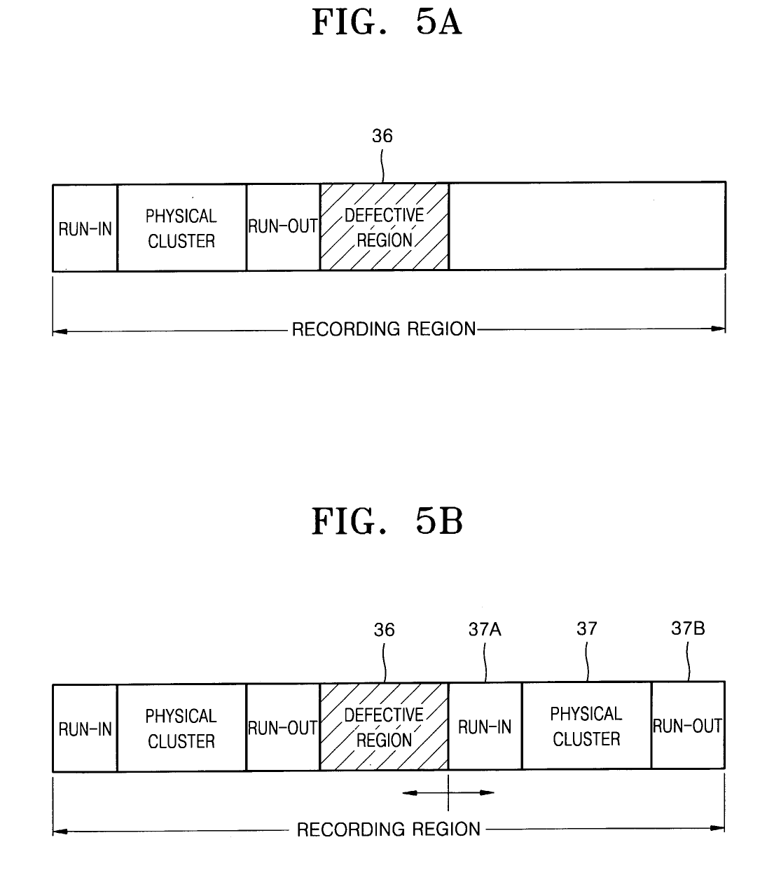

In particular, defective areas may be generated on an optical disc capable of recording and/or reproducing due to an address error or ID error. For example, if there is an address or ID error when recording is performed for the first time using a blank disc, run-ins and run-outs are not generated at a defective region 36, as shown in FIG. 5A. FIG. 5A shows a state in which recording is not performed after the defective region 36. Referring to FIG. 5B, when recording is performed after the defective region 36, a run-in 37A and a run-out 37B are provided before and after a physical cluster 37 after the defective region 36. In one implementation, linking is performed between a tail of the defective region 36 and a run-in 37A following after the defective region 36.

Defects due to such an address or ID error may be generated at the time of verifying discs. Also, defects may be generated when recording is performed on a blank disc with disc verification skipped. Unlike defects due to other causes, the defects due to an address or ID error do not generate run-ins and run-outs because no data is recorded on the defective region. Thus, it is desirable to treat defective regions caused by address errors differently from defective regions caused by other types of errors. In this case, as shown in FIG. 5B, linking occurs between a tail of the defective region 36 and a run-in 37A following after the defective region 36. Also, the guard2 in the last run-out 37B where recording is terminated is recorded to have a pattern different from that of a neighboring guard2, thereby performing recording of recording end data.

The present invention provides an optical disc recorded by the recording methods as described above. Referring to FIGS. 3B and 4B, the optical disc according to the present invention is designed so that linking occurs between a run-out 18′ or 28′ preceding the recording area A or B and the run-in 13A or 23B, respectively, when recording resumes after having recorded data. Here, recording refers to recording which is done continuously on a blank area next to the pre-recorded area, on which no previous recorded data is available, or in which overwriting is done on a portion of an area on which previous data has been recorded. The recording end data indicative of the end of recording is written before the defective region 26.

Furthermore, in the optical disc, linking also occurs between the run-out 28B′ and the run-in 23B″ following the defective region 26, and recording ends in the last run-out 18A and 28B″ of the recording area A and B, respectively. In this case, recording end data can be indicated by recording the guard2 of the last run-outs 18A and 28B″ to have a pattern different from that of a neighboring guard2.

Defective regions may be generated due to an address or ID error. As shown in FIG. 5A, run-ins and run-outs are not generated at the defective region 36. In FIG. 5B, a reliable physical cluster 37 is provided after the defective region 36, and the run-in 37A and the run-out 37B are provided before and after the physical cluster 37, respectively. In this case, linking is performed between a tail of the defective region 36 and the run-in 37A after the defective region 36.

When recording/reproducing on the optical disc according to the present invention, a light source having a wavelength of 900 nm or less or a light source of a blue wavelength may be used. An objective lens with a numerical aperture (NA) of 0.4-1.3 or more specifically, an objective lens with an NA of 0.7-1.3 may be used. In addition, the track pitch of the disc may be 1.6 μm or less and may be 0.35 μm or less. The smallest recording mark may have a length of 1 μm or less or more specifically, 0.2 μm or less. The smallest recording unit may have a size of more than 2 KB.

As described above, a system in which linking occurs upon continuous recording or overwriting of data over an optical disc, or occurrence of a defective region is defined and recording end data is recorded at an appropriate position, thereby ensuring more stable and reliable data recording/reproducing.

Furthermore, a data structure as shown in FIGS. 2A and 2B can be used as one for rewritable discs, write-once discs, or ROM discs which are read-only media.

An optical disc and a method of recording data on the optical disc according to the present invention is disclosed so that linking occurs before an area in which recording starts upon continuous recording or overwriting, or after the defective region upon recording over an area containing a defective region, thus enabling stable recording/reproducing of data.

Furthermore, data indicative of the end of recording is recorded on a run-out preceding a defective region in an optical disc containing the defective region, and recording ends in the last run-out of an area on which continuous recording or overwriting is performed. A standard for handling continuous recording, overwriting, and defective regions in an optical disc on which data is recorded is provided to ensure compatibility of a disc recording/reproducing apparatus thus improving reliability of recording/reproducing over the optical disc.

In addition, a data structure as shown in FIGS. 2A and 2B has an advantage of being used as one for rewritable discs, write-once discs, or ROM discs which are read-only media, thus maintaining consistency in data structure in terms of the physical format of discs.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of recording data on an optical disc, the method comprising:
performing linking before a physical cluster in which continuous recording starts.

2. The method of claim 1, wherein a run-in and a run-out are provided before and after the physical cluster, respectively, to accurately record data, and the linking occurs between the run-in and a preceding run-out of a preceding physical cluster in which recording starts.

3. The method of claim 2, further comprising:
recording data indicative of the end of recording in a last run-out of an area on which recording is to be performed.

4. The method of claim 3, wherein each run-in and each run-out contain guard1 and guard2 to protect user data, respectively, and the recording comprises recording the guard2 of the last run-out to have a pattern different from a neighboring guard2.

5. The method of claim 4, wherein the recording is continuously done on a blank area, on which no previous data has been recorded, next to a pre-recorded area.

6. The method of claim 4, wherein the recording is performed by overwriting data on a portion of an area on which previous data has been recorded.

7. The method of claim 1, further comprising:
recording data indicative of an end of recording on a last run-out of an area on which recording is to be performed.

8. The method of claim 7, wherein each run-in and each run-out contain a guard1 and a guard2 to protect user data, respectively, and further comprising:
recording the guard2 of the last run-out to have a pattern different from a neighboring guard2.

9. The method of claim 1, further comprising:
recording continuously on a blank area, on which no previous data has been recorded, next to a pre-recorded area.

10. The method of claim 1, further comprising:
recording by overwriting data on a portion of an area on which previous data has been recorded.

11. A method of recording data on an optical disc, the method comprising:
performing linking before a physical cluster on which continuous data recording starts, wherein a first run-in and a first run-out are located before and after the physical cluster; and
performing linking between a second run-in and a second run-out following a defective region when a recording area contains the defective region on which recording cannot be done.

12. The method of claim 11, wherein each first and second run-in contains a guard1 and each first and second run-out contains a guard2 protecting user data.

13. The method of claim 12, wherein an end of recording is indicated by making a pattern of the guard2 of a run-out preceding the defective region different from that of a neighboring guard2.

14. The method of claim 13, further comprising:
recording data continuously on a blank area, on which no previous data has been recorded, next to a pre-recorded area.

15. The method of claim 12, further comprising:
recording by overwriting data on a portion of an area on which previous data has been recorded.

16. The method of claim 12, further comprising:
recording a guard2 of a run-out following a last physical cluster on which data recording ends so that the guard2 includes a pattern different from that of a neighboring guard2 to indicate an end of recording.

17. The method of claim 11, further comprising:
recording on a blank area next to a pre-recorded area on which no previous data has been recorded.

18. The method of claim 11, further comprising:
recording by overwriting data on a portion of an area on which previous data has been recorded.

19. The method of claim 13, wherein the optical disc is one of a rewritable disc, a write-once disc, or a read-only disc and further comprising:
recording on the rewritable disc, the write-once disc, or the read-only disc.

20. An optical disc capable of storing recorded data, the optical disc comprising:
a plurality of physical clusters, each having data recorded thereon; and
a run-in and a run-out provided before and after each of the physical clusters, respectively, to accurately record data;
wherein linking occurs between a run-in of a physical cluster on which continuous recording starts and a preceding run-out of a preceding physical cluster.

21. The optical disc of claim 20, further comprising:
data indicative of an end of recording recorded on the a last run-out of an area on which data recording ends.

22. The optical disc of claim 21, wherein each run-out contains a guard2 protecting user data, and an end of recording is indicated by recording a last guard2 of the last run-out so that the last guard2 includes a pattern different from that of a neighboring guard2.

23. The optical disc of claim 21, further comprising a blank area;
wherein recording is continuously done on the blank area, on which no previous data has been recorded, next to a pre-recorded area.

24. The optical disc of claim 21, further comprising an area on which previous data has been recorded;
wherein recording is performed by overwriting data on a portion of the area on which previous data has been recorded.

25. The optical disc of claim 20, further comprising a blank area next to a prerecorded area on which no previous data has been recorded;
wherein recording is continuously done on the blank area next to the pre-recorded area on which no previous data has been recorded.

26. The optical disc of claim 20, further comprising an area on which previous data has been recorded;
wherein recording is performed by overwriting data on a portion of an area on which previous data has been recorded.

27. The optical disc of claim 20, wherein the optical disc is one of a rewritable disc, a write-once disc, or a read-only disc.

28. An optical disc capable of storing recorded data, the optical disc comprising:
a plurality of physical clusters, each configured to record data thereon;
a run-in and a run-out provided before and after each of the physical clusters, respectively, to accurately record data; and
a defective region having a defect occurring prior to recording data or during recording;
wherein, when continuous recording is done on an area on the optical disc containing the defective region and the physical clusters, linking occurs between a run-in before a physical cluster on which recording starts and a preceding run-out preceding the area on which recording starts.

29. The optical disc of claim 28, wherein data indicative of an end of recording is recorded on a run-out preceding the defective region.

30. The optical disc of claim 29, wherein each run-out contains a guard2 protecting user data, and the end of recording is indicated by recording a guard2 of the run-out preceding the defective region so that the guard2 includes a pattern different from that of a neighboring guard2.

31. The optical disc of claim 28, wherein linking occurs between a run-in and a run-out following the defective region.

32. The optical disc of claim 28, further comprising data indicative of an end of recording recorded on the last run-out of an area on which recording ends.

33. The optical disc of claim 32, wherein each run-out includes a guard2 protecting user data, and the end of recording is indicated by recording a last guard2 of the last run-out to have a pattern different from that of a neighboring guard2.

34. The optical disc of claim 28, further comprising a blank area next to a prerecorded area on which no previous data has been recorded;
wherein continuous recording is done on the blank area next to the pre-recorded area on which no previous data has been recorded.

35. The optical disc of claim 28, further comprising an area on which previous data has been recorded;
wherein recording is performed by overwriting data on a portion of an area on which previous data has been recorded.

36. The optical disc of claim 28, wherein the optical disc is one of a rewritable disc, a write-once disc, or a read-only disc.

37. The optical disc of claim 28, wherein the defective region may be generated due to an address or ID error; and
wherein linking is performed between a tail of the defective region and a run-in of a physical cluster after the defective region when the defective region is generated due to the address or ID error.

38. A method of recording data on an optical disc capable of storing recorded data, comprising:
performing linking between a tail of a defective region and a run-in of a physical cluster after the defective region when a defective region is generated due to an address or ID error.

39. A method recording on an optical disc, comprising:
linking in a portion of the optical disc where recording begins; and
terminating recording at a last run-out block of an area to be recorded on the optical disc.

40. The method of claim 39, further comprising:
recording data on the optical disc.

41. The method of claim 40, wherein the recording comprises continuous recording or overwriting of data.

42. The method of claim 40, wherein the optical disc comprises physical clusters to store data, a run-in before each physical cluster, and a run-out after each physical cluster, wherein:
the linking comprises linking between a run-in associated with a physical cluster where recording begins and a run-out associated with a preceding physical cluster before the physical cluster where the recording begins; and
the recording comprises beginning recording immediately after the run-out of the preceding physical cluster.

43. The method of claim 42, wherein the optical disc comprises a defective region and wherein the linking further comprises:
linking between a run-in and a run-out following the defective region.

44. The method of claim 43, further comprising:
storing an address of the defective region in a defect list region.

45. The method of claim 42, further comprising:
correcting data recording location errors by allowing data that is intended to be written to a data frame in the physical cluster to be written to an allowable range of each run-in or each run-out.

46. The method of claim 42, wherein each run-in comprises a guard1 having a predetermined pattern and further comprising:
preventing overwriting of data with the guard1.

47. The method of claim 42, wherein each run-out comprises a guard2 having a predetermined pattern and further comprising:
preventing overwriting of data with the guard2.

48. The method of claim 42, wherein each run-in comprises a pre-amble and further comprising:
signal processing with the pre-amble.

49. The method of claim 42, wherein each run-out comprises a post-amble and further comprising:
signal processing with the post-amble.

50. The method of claim 40, wherein the recording comprises:
recording on a blank area on which no previous data has been recorded, recording next to a pre-recorded area, or overwriting data on a portion of an area on which previous data has been recorded.

51. The method of claim 39, wherein the linking further comprises:
linking between a run-out preceding a recording area and a run-in preceding the recording area such that recording starts in the recording area.

52. The method of claim 39, wherein the linking comprises:
linking before a physical cluster so that a location error within a predetermined allowable range is corrected when an accurate recording start point is not found.

53. The method of claim 39, wherein the optical disc comprises a defective region caused by an address error and the linking further comprises:
linking between a tail of the defective region and a run-in following the defective region to correct the address error.

54. The method of claim 40, further comprising:
providing a light source having a wavelength of 900 nm or less; and
wherein the recording comprises recording with the provided light source.

55. The method of claim 54, wherein the providing comprises:
providing the light source having an objective lens with a numerical aperture 0.7-1.3.

56. The method of claim 39, further comprising:
providing an optical disc having a track pitch 0.35 μm or less.

57. A recording structure on an optical disc, comprising:
termination data indicative of termination of recording written before a defective region; and
linking data after the defective region;
wherein the termination data and the linking data enable seamless recording on the optical disc with the defective region.

58. The recording structure of claim 57, further comprising:
physical clusters configured to store data thereon;
a run-in before each physical cluster; and
a run-out after each physical cluster.

59. The recording structure of claim 58, wherein:
each run-in includes a guard1; and
each run-out includes a guard2;
wherein each guard1 and each guard2 protect user data and a last guard2 of a last run-out comprises a recording pattern differing from a neighboring guard2 to indicate an end of recording after the last guard2.

60. The recording structure of claim 59, wherein each guard2 comprises a length of 300 channel bits.

61. The recording structure of claim 59, wherein each guard2 comprises a pattern containing a 3T or a 5T length of a mark recorded on the optical disc.

62. The recording structure of claim 58, wherein the physical clusters each comprise:
data frames each having a 2 KB capacity;
a synch frame indicating synchronization;
offset control data controlling offset; and
an error correction code (ECC) correcting errors.

63. The recording structure of claim 57, further comprising:
recording units configured to store recorded data.

64. The recording structure of claim 63, wherein the recording units comprise sectors.

65. The recording structure of claim 63, wherein the recording units comprise ECC blocks.

66. The recording structure of claim 63, wherein the recording units comprise frames.

67. The recording structure of claim 57, wherein the optical disc comprises:
a rewritable disc, a write-once disc, or a ROM disc; and
wherein an identical physical format for the recording structure is used in each of the rewritable disc, the write-once disc, or the ROM disc.

68. A recording method on an optical disc, comprising:
resuming recording on a recording area of the optical disc; and
linking a run-out preceding the recording area and a first run-in of the recording area upon the resuming the recording.

69. A method of enabling stable recording on an optical disc, comprising:
beginning recording data on the optical disc;
linking before a recording area upon the beginning recording; and
linking after a defective region after the beginning recording if the recording area includes the defective region.
